(19) United States
(12) Patent Application Publication
(10) Pub. No.: US 2023/0363461 A1
(43) Pub. Date: Nov. 16, 2023

(54) AEROSOL-FORMING APPARATUS

(71) Applicant: SHENZHEN SMOORE TECHNOLOGY LIMITED, Shenzhen (CN)

(72) Inventors: Hongming ZHOU, Shenzhen (CN); Taowen LIU, Shenzhen (CN); Wenli DU, Shenzhen (CN); Junjie XIAO, Shenzhen (CN); Xiong YU, Shenzhen (CN)

(21) Appl. No.: 18/353,798

(22) Filed: Jul. 17, 2023

Related U.S. Application Data
(63) Continuation of application No. PCT/CN2021/143989, filed on Dec. 31, 2021.

(30) Foreign Application Priority Data
Jan. 18, 2021 (CN) 202120132016.3

(51) Int. Cl. A24F 40/465; A24F 1/30; A24F 40/10; A24F 40/42; H05B 6/10

(52) U.S. Cl. CPC A24F 40/465; A24F 1/30; A24F 40/10; A24F 40/42; H05B 6/108

(57) ABSTRACT

An aerosol-forming apparatus includes: a vaporization assembly having: a liquid storage body with a liquid storage vaporization cavity for storing aerosol-forming substrate; and a heating body for heating and vaporizing the aerosol-forming substrate when power is applied. The heating body is slidably connected to the liquid storage body between a first location and a second location. The heating body is located outside the aerosol-forming substrate when the heating body is located at the first location. At least a part of the heating body protrudes into the aerosol-forming substrate when the heating body is located at the second location.

### CROSS-REFERENCE TO PRIOR APPLICATION

This application is a continuation of International Patent Application No. PCT/CN2021/143989, filed on Dec. 31, 2021, which claims priority to Chinese Patent Application No. 202120132016.3, filed on Jan. 18, 2021. The entire disclosure of both applications is hereby incorporated by reference herein.

### FIELD

The present invention relates to the technical field of vaporization devices, and in particular, to an aerosol-forming apparatus.

### BACKGROUND

An aerosol-forming apparatus is an apparatus that vaporizes aerosol-forming substrate into an aerosol, and is widely used in a medical device and an electronic vaporization apparatus.

Currently, the aerosol-forming apparatus generally includes a vaporization assembly and a power supply assembly. The vaporization assembly includes a heating body, and the heating body is configured to heat and vaporize the aerosol-forming substrate when power is applied. The power supply assembly is electrically connected to the vaporization assembly, and is configured to supply power to the heating body. However, in an existing aerosol-forming apparatus, a heating body thereof generally protrudes into aerosol-forming substrate to heat aerosol-forming substrate, a heating manner is relatively single, and a vaporization speed is relatively slow.

### SUMMARY

In an embodiment, the present invention provides an aerosol-forming apparatus, comprising: a vaporization assembly, comprising: a liquid storage body having a liquid storage vaporization cavity configured to store aerosol-forming substrate; and a heating body configured to heat and vaporize the aerosol-forming substrate when power is applied, wherein the heating body is slidably connected to the liquid storage body between a first location and a second location, wherein the heating body is located outside the aerosol-forming substrate when the heating body is located at the first location, and wherein at least a part of the heating body protrudes into the aerosol-forming substrate when the heating body is located at the second location.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram after a vaporization assembly and a power supply assembly are assembled according to an embodiment of this application;

FIG. 2 is a schematic structural diagram after a vaporization assembly and a power supply assembly are disassembled according to an embodiment of this application;

FIG. 3 is a schematic diagram of an overall structure of a vaporization assembly according to an embodiment of this application;

FIG. 4 is a schematic diagram of disassembling the structure shown in FIG. 3 according to an embodiment of this application;

FIG. 5 is a schematic structural diagram of a heating body at a first location according to an embodiment of this application;

FIG. 6 is a schematic structural diagram of a heating body at a second location according to an embodiment of this application;

FIG. 7 is a schematic structural diagram in which a slider of a heating body protrudes into a chute according to an embodiment of this application;

FIG. 8 is a schematic structural diagram in which a slider of a heating body and a chute are aligned according to an embodiment of this application; and

FIG. 9 is a schematic structural diagram in which a slider of a heating body deviates from a chute according to an embodiment of this application.

### DETAILED DESCRIPTION

In an embodiment, the present invention provides an aerosol-forming apparatus. The apparatus can resolve the problem that a heating manner of a vaporization assembly of an existing aerosol-forming apparatus is relatively single, and a vaporization speed is relatively slow.

In an embodiment, the present invention provides an aerosol-forming apparatus. The aerosol-forming apparatus includes a vaporization assembly. The vaporization assembly includes a liquid storage body and a heating body. The liquid storage body has a liquid storage vaporization cavity, where the liquid storage vaporization cavity is configured to store aerosol-forming substrate; and the heating body is configured to heat and vaporize the aerosol-forming substrate when power is applied. The heating body is slidably connected to the liquid storage body between a first location and a second location, the heating body is located outside the aerosol-forming substrate when the heating body is located at the first location, and at least a part of the heating body protrudes into the aerosol-forming substrate when the heating body is located at the second location.

The vaporization assembly further includes a cover body; the cover body is disposed at the port of the liquid storage vaporization cavity to seal the liquid storage vaporization cavity, and the cover body has a through hole that is in communication with the liquid storage vaporization cavity; and the heating body includes an extension part that penetrates through the through hole, and a heating part that is connected to the extension part and located in the liquid storage vaporization cavity, and the extension part is slidably connected to the liquid storage body through the through hole, for the heating part to disengage from or protrudes into the aerosol-forming substrate.

The cover body has a protrusion on the surface of the side facing the liquid storage body, the protrusion has a chute in communication with the through hole, the part of the heating body that protrudes into the liquid storage vaporization cavity has a slider, the slider moves along the chute, and the slider is detached from the chute when the heating body is located at the second location.

The heating body is rotatably connected to the cover body to align or deviate the slider with the chute.

The vaporization assembly further includes an elastic member configured to provide an acting force toward the first location to the heating body when the heating body is located at the second location.

The heating body further includes a stop that circumferentially extends at the end that is of the extension part and that is away from the heating part, the elastic member is sleeved on the extension part, one end of the elastic member abuts against the stop, and the other end thereof abuts against the cover body.

The elastic member is a spring, the elastic member is sleeved on the heating body, and one end of the elastic member abuts against an end stop of the heating body, and the other end abuts against the cover body.

The vaporization assembly further includes a sealing member sleeved on the outer surface of the liquid storage body for fixing the cover body and sealing the connection location between the cover body and the liquid storage body.

The vaporization assembly further includes a cooling body detachably connected to the liquid storage body for cooling an aerosol generated by the heating body through vaporization.

The cooling body includes a connecting part and a cooling part. The connecting part is detachably connected to the liquid storage body, and is in communication with the liquid storage vaporization cavity; and the cooling part is in communication with the connecting part and is configured to accommodate condensate.

The aerosol-forming apparatus further includes a power supply assembly detachably connected to the vaporization assembly to supply power to the vaporization assembly.

The power supply assembly includes a housing, a battery, a circuit board, and a coil. The housing has an accommodating cavity; the battery is accommodated in the accommodating cavity and configured to provide electric energy; the circuit board is accommodated in the accommodating cavity and connected to the battery; and the coil is formed in the circumferential direction of the heating body and in electric communication with the circuit board, configured to generate a magnetic field when power is applied, for the heating body to heat up by means of electromagnetic induction.

A first recession part is formed on the surface of one side of the housing, the coil is disposed on the inner surface of the first recession part in the circumferential direction of the first recession part, and at least a part of the liquid storage body and at least a part of the heating body are located in the first recession part, for the heating body to heat up by means of electromagnetic induction when the coil is energized.

A second recession part is further formed on the surface of one side of the housing, the vaporization assembly further includes a cooling body, the cooling body includes a cooling part in communication with the liquid storage vaporization cavity, and at least a part of the cooling part is accommodated in the second recession part to fix the cooling body.

According to the aerosol-forming apparatus provided in this application, a vaporization assembly is disposed, and the vaporization assembly is disposed to include a liquid storage body and a heating body, where the liquid storage body has a liquid storage vaporization cavity, so that aerosol-forming substrate is stored in the liquid storage vaporization cavity, and the heating body heats and vaporizes the aerosol-forming substrate when power is applied. In addition, the heating body is slidably connected to the liquid storage body between a first location and a second location, and when the heating body is located at the first location, the heating body is located outside the aerosol-forming substrate, and when the heating body is located at the second location, at least a part of the heating body protrudes into the aerosol-forming substrate, so that the heating body not only can protrude into the aerosol-forming substrate to heat the aerosol-forming substrate, but also can heat a small quantity of aerosol-forming substrates bonded to the heating body outside the aerosol-forming substrate, which not only increases heating manners of the heating body, but also implements diversified heating manners of the heating body. In addition, when the heating body is outside the aerosol-forming substrate, only a small quantity of aerosol-forming substrates bonded to the heating body need to be heated and vaporized. Compared with a solution of heating all aerosol-forming substrates in the prior art, a vaporization speed is effectively increased, and a vaporization amount per unit time is increased.

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

The terms “first”, “second”, and “third” in this application are merely intended for a purpose of description, and shall not be understood as an indication or implication of relative importance or implicit indication of the number of indicated technical features. Therefore, features defining “first”, “second”, and “third” can explicitly or implicitly include at least one feature. In description of this application, “multiple” means at least two, such as two and three unless it is specifically defined otherwise. All directional indications (for example, up, down, left, right, front, back . . . ) in the embodiments of this application are only used for explaining relative position relationships, movement situations, or the like between the various components in a specific posture (as shown in the accompanying drawings). If the specific posture changes, the directional indications change accordingly. In addition, the terms “include”, “have”, and any variant thereof are intended to cover a non-exclusive inclusion. For example, a process, method, system, product, or device that includes a series of steps or units is not limited to the listed steps or units, but further optionally includes a step or unit that is not listed, or further optionally includes another step or unit that is intrinsic to the process, method, product, or device.

Embodiment mentioned in the specification means that particular features, structures, or characteristics described with reference to the embodiment may be included in at least one embodiment of this application. The term appearing at different positions of this specification may not refer to the same embodiment or an independent or alternative embodiment that is mutually exclusive with another embodiment. A person skilled in the art explicitly or implicitly understands that the embodiments described in the specification may be combined with other embodiments.

The following describes this application in detail with reference to the accompanying drawings and embodiments.

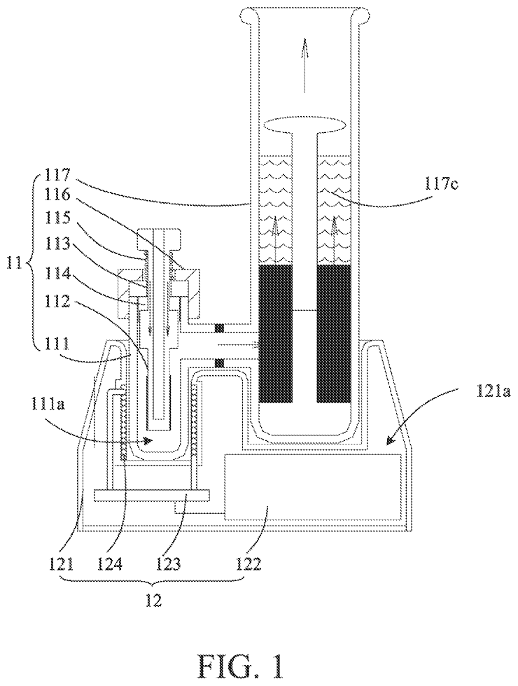

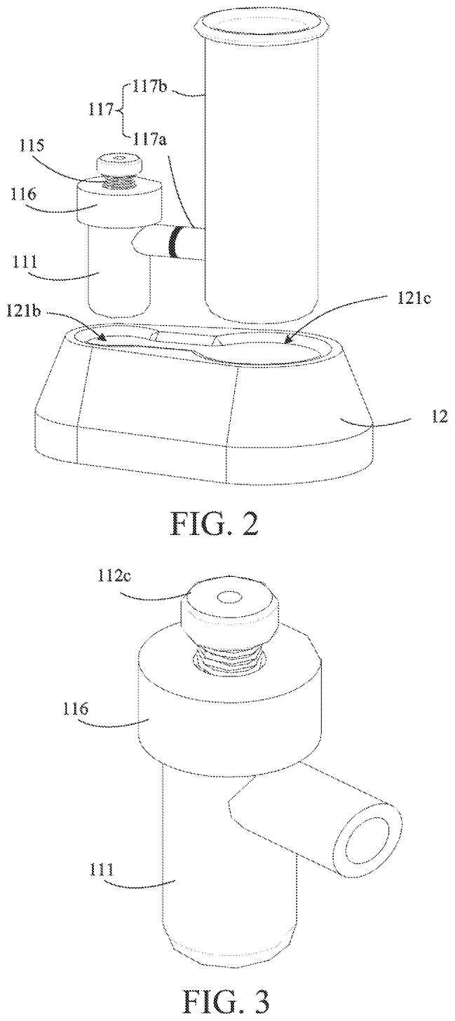

Referring to FIG. 1 and FIG. 2, FIG. 1 is a schematic structural diagram after a vaporization assembly and a power supply assembly are assembled according to an embodiment of this application. FIG. 2 is a schematic structural diagram after a vaporization assembly and a power supply assembly are disassembled according to an embodiment of this application. In this embodiment, an aerosol-forming apparatus is provided. The aerosol-forming apparatus can heat and vaporize aerosol-forming substrate when power is applied, so as to form an aerosol for inhaling by a user. Specifically, the aerosol-forming apparatus may be a smoking set, and the aerosol-forming substrate may be cannabis paste or oil.

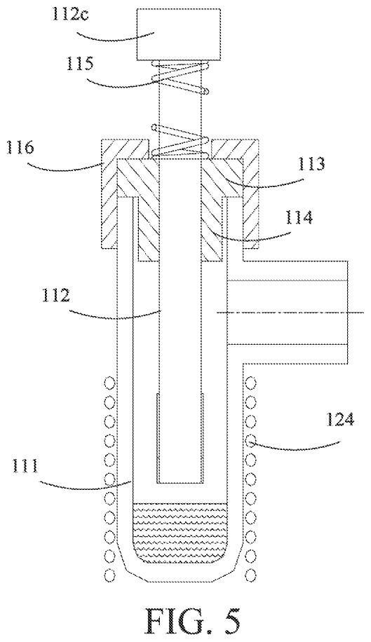

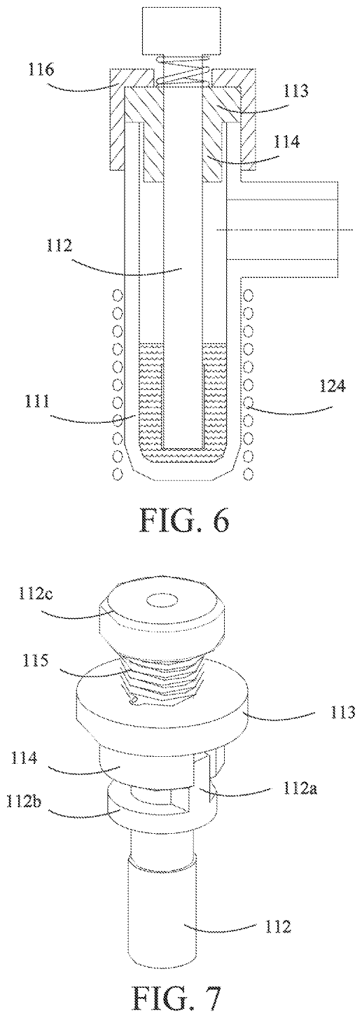

Specifically, the aerosol-forming apparatus includes a vaporization assembly 11 and a power supply assembly 12. The vaporization assembly 11 is configured to heat and vaporize aerosol-forming substrate 111b when power is applied (see FIG. 5 and FIG. 6). The power supply assembly 12 is detachably connected to the vaporization assembly 11, and is configured to supply power to the vaporization assembly 11 after the vaporization assembly 11 and the power supply assembly 12 are assembled. For a product structure after the power supply assembly 12 and the vaporization assembly 11 are assembled, refer to FIG. 1. For a product structure after disassembly, refer to FIG. 2. Because the power supply assembly 12 is detachably connected to the vaporization assembly 11, when the vaporization assembly 11 and the power supply assembly 12 are cleaned, the vaporization assembly 11 and the power supply assembly 12 may be separated, thereby facilitating cleaning of the vaporization assembly 11 and the power supply assembly 12.

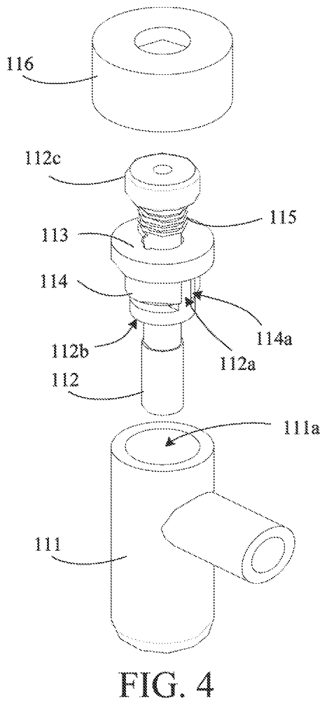

Referring to FIG. 3 and FIG. 4, FIG. 3 is a schematic diagram of an overall structure of a vaporization assembly according to an embodiment of this application. FIG. 4 is a schematic diagram of disassembling the structure shown in FIG. 3 according to an embodiment of this application. The vaporization assembly 11 includes a liquid storage body 111 and a heating body 112. The liquid storage body 111 may be specifically a tubular structure, and a liquid storage vaporization cavity 111a is formed on the surface of one side of the liquid storage body 111, so that aerosol-forming substrate 111b is stored in the liquid storage vaporization cavity 111a. The heating body 112 may be a rod-shaped body, configured to heat and vaporize the aerosol-forming substrate 111b when power is applied.

In a specific embodiment, referring to FIG. 5 and FIG. 6, FIG. 5 is a schematic structural diagram of a heating body at a first location according to an embodiment of this application. FIG. 6 is a schematic structural diagram of a heating body at a second location according to an embodiment of this application. The heating body 112 is slidably connected to the liquid storage body 111 between a first location and a second location in the axial direction of the heating body 112. In addition, when the heating body 112 is located at the first location, the heating body 112 is located outside the aerosol-forming substrate 111b. In this case, for a specific location relationship between the heating body 112 and the liquid storage body 111, refer to FIG. 5. In this case, a part of the heating body 112 is still located in the liquid storage vaporization cavity 111a, but does not contact the aerosol-forming substrate 111b. When the heating body 112 is located at the second location, at least a part of the heating body 112 protrudes into the aerosol-forming substrate 111b. In this case, for a specific location relationship between the heating body 112 and the liquid storage body 111, refer to FIG. 6. In this way, the heating body 112 can protrude into the aerosol-forming substrate 111b to heat the aerosol-forming substrate 111b, or heat a small quantity of aerosol-forming substrates 111b bonded to the heating body 112 outside the aerosol-forming substrate 111b, so that not only heating manners of the heating body 112 are increased, but also heating manners of the heating body 112 are diversified. In addition, in a specific embodiment, after the heating body 112 returns from the second location to the first location, a small quantity of aerosol-forming substrates 111b are bonded to the part of the heating body 112 that protrudes into the aerosol-forming substrate 111b. In this case, the heating body 112 only needs to heat and vaporize the small quantity of aerosol-forming substrates 111b. In comparison with a solution of protruding into the aerosol-forming substrate 111b to vaporize the aerosol-forming substrate 111b, an amount of aerosol-forming substrates 111b that need to be heated and vaporized each time is greatly reduced, so that vaporization efficiency is effectively improved, a vaporization time is shortened, a user can inhale a specific amount of aerosols each time, and a mouthfeel of the user is ensured.

In a specific embodiment, referring to FIG. 1 to FIG. 4, the vaporization assembly 11 further includes a cover body 113. The cover body 113 may be specifically disposed at the port of the liquid storage vaporization cavity 111a, to seal the liquid storage vaporization cavity 111a, so as to prevent an aerosol generated by vaporization from being exposed from the port of the liquid storage vaporization cavity 111a. Specifically, a through hole is formed in the cover body 113, and the through hole is in communication with the liquid storage vaporization cavity 111a. In a specific embodiment, the heating body 112 specifically includes an extension part and a heating part that is axially connected to the extension part. The extension part is specifically disposed in the through hole, and is slidably connected to the liquid storage body 111 through the through hole, for the heating part to disengage from or protrudes into the aerosol-forming substrate 111b. The heating part is located in the liquid storage vaporization cavity 111a, and is configured to heat and vaporize the aerosol-forming substrate 111b when power is applied.

In a specific embodiment, the through hole may be disposed at the central location of the cover body 113, and the part that is of the heating body 112 penetrating through the through hole and that is disposed in the liquid storage vaporization cavity 111a is disposed at an interval with the inner surface of the liquid storage vaporization cavity 111a. In comparison with a solution in which the heating body 112 abuts against the inner surface of the liquid storage vaporization cavity 111a, heat of the heating body 112 being conducted to the liquid storage body 111 can be reduced, a heat loss can be reduced, and the outer wall of the aerosol-forming apparatus can be ensured to be at a proper temperature for a human body. In addition, center heating can be implemented, and uniformity of heating can be improved.

In an embodiment, the surface of one side of the cover body 113 that faces the liquid storage body 111 further has a protrusion 114, where the protrusion 114 specifically penetrates through the liquid storage vaporization cavity 111a, and may interference fit with the inner surface of the liquid storage vaporization cavity 111a, so as to improve sealing performance of the liquid storage vaporization cavity 111a. Specifically, the protrusion 114 has a chute 114a that is in communication with the through hole. The part of the heating body 112 that protrudes into the liquid storage vaporization cavity 111a has a slider 112a. The slider 112a may move along the chute 114a, so that the heating body 112 is at the first location or the second location. The material of the cover body 113 and/or the protrusion 114 may be high-temperature-resistant metal, plastic, ceramic, or the like.

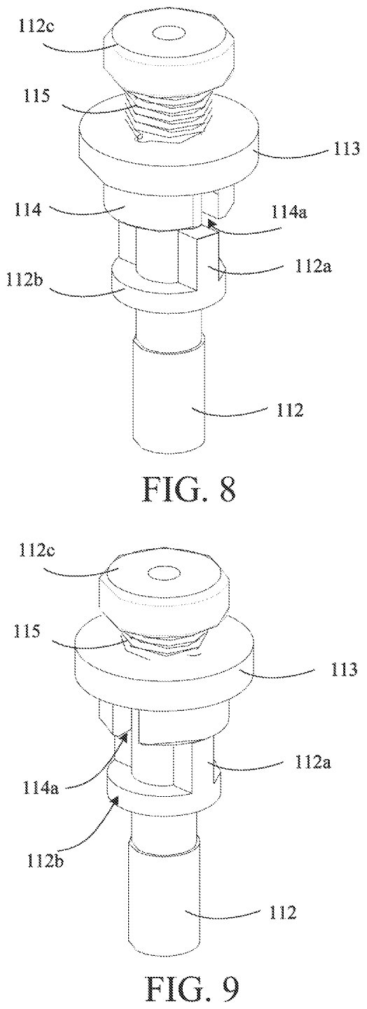

Specifically, referring to FIG. 7 to FIG. 9, FIG. 7 is a schematic structural diagram in which a slider of a heating body protrudes into a chute according to an embodiment of this application; FIG. 8 is a schematic structural diagram in which a slider of a heating body and a chute are aligned according to an embodiment of this application; and FIG. 9 is a schematic structural diagram in which a slider of a heating body deviates from a chute according to an embodiment of this application. When the heating body 112 is at the first location, at least a part of the slider 112a is located in the chute 114a (refer to FIG. 7), and the vertical distance between the surface of one side of the slider 112a facing the cover body 113 and the surface of one side of the protrusion 114 that is away from the cover body 113 is less than or equal to the vertical distance between the first location of the heating body 112 and the second location of the heating body 112, so that when the heating body 112 is at the second location after the heating body 112 is depressed, the slider 112a can fall off the limitation of the chute 114a, and the heating body 112 can be further rotated, so that the slider 112a and the chute 114a are aligned or deviated. For a structure in which the slider 112a and the chute 114a are aligned, refer to FIG. 8. For a specific structure in which the slider 112a and the chute 114a are deviated, refer to FIG. 9. When the heating body 112 is at the second location, the heating body 112 is rotatable and clamped to the side wall of the chute 114a by using the slider 112a, so that the heating body 112 can be fixed at a horizontal height of the second location, and at least a part of the heating body 112 is always located in the aerosol-forming substrate 111b, that is, at least a part of the heating body 112 is always in contact with the aerosol-forming substrate 111b. In this way, the problem that a user needs to press the heating body 112 each time during inhaling can be avoided, and an operation is relatively simple. Specifically, a heating solution in which the slider 112a is clamped on the side wall of the chute 114a is specifically similar to that of a conventional Cannabis smoking set.

Specifically, a rotation angle may be 10 degrees to 120 degrees.

The chute 114a may extend along the axial direction of the protrusion 114 from the surface of one side of the protrusion 114 opposite to the through hole to the surface of one side back to back to the through hole, and the chute 114a may penetrate the side wall of the protrusion 114 along the radial direction of the protrusion 114. That is, the chute 114a may be a through groove in both the axial direction and the radial direction of the chute 114a. There may be two sliders 112a, and the two sliders 112a may be disposed opposite to each other on two sides of the heating body 112. Specifically, the slider 112a may be a rectangular block disposed along the axial direction of the heating body 112, and the size of the rectangular block along the axial direction of the heating body 112 is greater than or equal to the size of the chute 114a along the axial direction of the heating body 112. The size of the rectangular block in the radial direction of the heating body 112 matches the radial sizes at corresponding locations of the chute 114a and the slider 112a, and the radial size at a corresponding location of the chute 114a for the heating body 112 matches the radial size of the heating body 112.

In a specific embodiment, an annular protrusion 112b is further disposed on the outer surface of the heating body 112. The annular protrusion 112b may be specifically disposed on the end of the slider 112a that is away from the cover body 113, and may be integrally formed with the slider 112a. The annular protrusion 112b is configured to limit movement of the heating body 112 in the direction that faces the first location, so as to prevent the heating body 112 from falling from the liquid storage body 111.

In a specific embodiment, referring to FIG. 1 to FIG. 8, the vaporization assembly 11 further includes an elastic member 115. The elastic member 115 is disposed along the axial direction of the heating body 112, and is configured to provide an acting force toward the first location to the heating body 112 when the heating body 112 is at the second location.

In a specific embodiment, the heating body 112 further includes a stop 112c, where the stop 112c extends circumferentially from the end that is of the extension part and that is away from the heating part, that is, the stop 112c is disposed at the end that is of the extension part and that is away from the heating part, and extends in the circumferential direction of the extension part. The radial size of the stop 112c is greater than the radial size of the extension part. In a specific embodiment, one end of the elastic member 115 abuts against the stop 112c of the heating body 112, and the other end abuts against the cover body 113. In addition, when the heating body 112 is at the first location, the elastic member 115 is in the naturally elongated state, and when the heating body 112 is at the second location, the elastic member 115 is in the compressed state, so as to provide, by using the stop 112c, the heating body 112 with a driving force that moves toward the first location.

Specifically, the elastic member 115 may be a spring, and may be specifically sleeved on the outer surface of the heating body 112.

In a specific embodiment, when the aerosol needs to be inhaled, the heating body 112 may be pressed by using an external force, so that the heating body 112 moves from the first location to the second location and contacts the aerosol-forming substrate 111b (refer to FIG. 6). After the external force is removed, the heating body 112 moves to the first location under an elastic force that is of the elastic member 115 and that restores a natural elongation state of the heating body 112 (refer to FIG. 5). In this case, a small quantity of aerosol-forming substrates 111b are bonded to the location at which the heating body 112 contacts the aerosol-forming substrate 111b. The heating body 112 heats and vaporizes the small quantity of aerosol-forming substrates 111b, and may rapidly generate a large quantity of aerosols in 5-10 seconds, which effectively improves vaporization efficiency. In addition, the user can control the quantity of press times according to the satisfaction of the user, and cultivate a personal inhalation habit.

In a specific embodiment, the vaporization assembly 11 may further include a sealing member 116. The sealing member 116 may be sleeved on the outer surface of the liquid storage body 111, and wrap the surface of one side of the cover body 113 that is away from the liquid storage body 111, so as to fix the cover body 113 and seal the connection location between the cover body 113 and the liquid storage body 111.

In a specific embodiment, referring to FIG. 1 and FIG. 2, the vaporization assembly 11 further includes a cooling body 117. The cooling body 117 is detachably connected to and is in communication with the liquid storage body 111, and is configured to cool the aerosol generated by the heating body 112 through vaporization. Specifically, the cooling body 117 may be a water filter.

Specifically, the cooling body 117 may include a connecting part 117a and a cooling part 117b. The connecting part 117a is detachably connected to the liquid storage body 111, and is in communication with the liquid storage vaporization cavity 111a. The connecting part 117a may be specifically detachably connected to the heating body 112 in a threaded or plugged manner. In this way, the liquid storage body 111 and the cooling body 117 can be quickly separated, so as to facilitate cleaning inside the container. Specifically, the cooling part 117b is in communication with the connecting part 117a, and is configured to accommodate condensate 117c. In a specific embodiment, the aerosol generated by the heating body 112 through vaporization enters, by using the connecting part 117a, the condensate 117c stored in the cooling part 117b, so as to cool the aerosol by using the condensate 117c, and filter out other impurities carried in the aerosol.

Specifically, the cooling part 117b may be integrally formed with the connecting part 117a. In addition, the connecting part 117a may be specifically disposed at the middle location of the cooling part 117b.

The power supply assembly 12 may specifically include a housing 121, a battery 122, a circuit board 123, and a coil 124. The battery 122 may be specifically a lithium battery.

Specifically, the housing 121 has an accommodating cavity 121a, and the battery 122 and the circuit board 123 may be specifically accommodated in the accommodating cavity 121a. The circuit board 123 is connected to the battery 122, and the battery 122 is configured to provide power for the circuit board 123. The coil 124 is formed in the circumferential direction of the heating body 112, in electric communication with the circuit board 123, and is configured to generate a magnetic field when power is applied, so that the heating body 112 heats up by means of electromagnetic induction. Because the heating body 112 heats up by means of electromagnetic induction, the aerosol-forming substrate 111b can be quickly and evenly heated without contacting the coil 124. Compared with a solution in which an electrical connection manner is directly used, the non-contact heating by means of electromagnetic induction heating can disassemble the vaporization assembly 11 and the power supply assembly 12 at any time, and the disassembly is relatively convenient.

In a specific embodiment, a first recession part 121b is formed on the surface of one side of the housing 121, and the coil 124 is specifically disposed on the inner surface of the first recession part 121b along the circumferential direction of the first recession part 121b. At least a part of the liquid storage body 111 is located in the first recession part 121b, so as to implement a detachable connection between the vaporization assembly 11 and the power supply assembly 12. Specifically, at least a part of the heating body 112 is also located in the first recession part 121b, so that when the coil 124 is energized, the heating body 112 is located in the magnetic field generated by the coil 124, and further generates a current and heats up by means of electromagnetic induction, so as to heat and vaporize the aerosol-forming substrate 111b.

Specifically, a second recession part 121c is further formed on the surface of one side of the housing 121, the second recession part 121c and the first recession part 121b are located on the same side of the housing 121 and are in communication with each other, and at least a part of the cooling part 117b is specifically accommodated in the second recession part 121c, so as to fix the cooling body 117. Specifically, the location at which the liquid storage body 111 is connected to the connecting part 117a and the connecting part 117a are located in a cavity in which the first recession part 121b is in communication with the second recession part 121c, so as to fix the two.

In a specific embodiment, at least a part of the liquid storage body 111 and at least a part of the cooling part 117b may be directly inserted into the first recession part 121b and the second recession part 121c. In this way, the vaporization assembly 11 and the power supply assembly 12 can be quickly separated, so as to facilitate cleaning.

According to the aerosol-forming apparatus provided in this embodiment, the heating body 112 is inserted into the aerosol-forming substrate 111b such as cannabis paste or oil, so that heat generated by magnetic induction heating can be fully absorbed by the aerosol-forming substrate 111b such as cannabis paste or oil, and the energy conversion efficiency is greater than or equal to 75%. Compared with a solution in which the energy conversion efficiency of conventional circumferential circle heating or bottom heating is about 50%, the energy conversion rate is greatly increased, thereby effectively improving the service life of the aerosol-forming apparatus.

According to the aerosol-forming apparatus provided in this embodiment, a vaporization assembly 11 is disposed, and the vaporization assembly 11 is disposed to include a liquid storage body 111 and a heating body 112, where the liquid storage body 111 has a liquid storage vaporization cavity 111a, so that aerosol-forming substrate 111b is stored in the liquid storage vaporization cavity 111a, and the aerosol-forming substrate 111b is heated and vaporized by the heating body 112 when being energized. In addition, the heating body 112 is slidably connected to the liquid storage body 111 between a first location and a second location, and when the heating body 112 is located at the first location, the heating body 112 is located outside the aerosol-forming substrate 111b, and when the heating body 112 is located at the second location, at least a part of the heating body 112 protrudes into the aerosol-forming substrate 111b, so that the heating body 112 not only can protrude into the aerosol-forming substrate 111b to heat the aerosol-forming substrate 111b, but also can heat a small quantity of aerosol-forming substrates 111b bonded to the heating body 112 outside the aerosol-forming substrate 111b, which not only increases heating manners of the heating body 112, but also implements diversified heating manners of the heating body 112. In addition, when the heating body 112 is at the first location, the heating body 112 only needs to heat and vaporize a small quantity of aerosol-forming substrates 111b bonded to the heating body 112. Compared with a solution of heating all aerosol-forming substrates 111b in the prior art, a vaporization speed is effectively increased, and a vaporization amount per unit time is increased. In addition, the power supply assembly 12 is disposed, so as to supply power to the vaporization assembly 11 by using the power supply assembly 12, and the power supply assembly 12 is detachably connected to the vaporization assembly 11, so that when the vaporization assembly 11 and the power supply assembly 12 are cleaned, the vaporization assembly 11 and the power supply assembly 12 can be quickly separated, thereby facilitating cleaning of the vaporization assembly 11 and the power supply assembly 12. In addition, by means of electromagnetic induction heating, rapid and even heating can be performed without contacting the coil 124. In addition, when the heating body 112 is located at the second location, the heating body 112 may be rotated to be clamped onto the side wall of the chute 114a, so that the heating body 112 can always be located in the aerosol-forming substrate 111b. Therefore, the user does not need to press the heating body 112 each time for inhalation, and an operation is relatively simple.

The foregoing descriptions are merely implementations of this application, and the patent scope of this application is not limited thereto. All equivalent structure or process changes made according to the content of this specification and accompanying drawings in this application or by directly or indirectly applying this application in other related technical fields shall similarly fall within the patent protection scope of this application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An aerosol-forming apparatus, comprising:
a vaporization assembly, comprising:
a liquid storage body having a liquid storage vaporization cavity configured to store aerosol-forming substrate; and
a heating body configured to heat and vaporize the aerosol-forming substrate when power is applied,
wherein the heating body is slidably connected to the liquid storage body between a first location and a second location,
wherein the heating body is located outside the aerosol-forming substrate when the heating body is located at the first location, and
wherein at least a part of the heating body protrudes into the aerosol-forming substrate when the heating body is located at the second location.

2. The aerosol-forming apparatus of claim 1, wherein the vaporization assembly further comprises:
a cover body disposed at a port of the liquid storage vaporization cavity so as to seal the liquid storage vaporization cavity, and having a through hole in communication with the liquid storage vaporization cavity, and
wherein the heating body comprises an extension part that penetrates through the through hole,
wherein a heating part that is connected to the extension part and located in the liquid storage vaporization cavity, and
wherein the extension part is slidably connected to the liquid storage body through the through hole for the heating part to disengage from or protrude into the aerosol-forming substrate.

3. The aerosol-forming apparatus of claim 2, wherein the cover body has a protrusion on a surface of the side facing the liquid storage body, the protrusion having a chute in communication with the through hole,
wherein a part of the heating body that protrudes into the liquid storage vaporization cavity has a slider, the slider being configured to move along the chute, and the slider being detached from the chute when the heating body is located at the second location.

4. The aerosol-forming apparatus of claim 3, wherein the heating body is rotatably connected to the cover body to align or deviate the slider with the chute.

5. The aerosol-forming apparatus of claim 2, wherein the vaporization assembly further comprises an elastic member configured to provide an acting force toward the first location to the heating body when the heating body is located at the second location.

6. The aerosol-forming apparatus of claim 5, wherein the heating body further comprises a stop that circumferentially extends at an end that is of the extension part and that is away from the heating part,
wherein the elastic member is sleeved on the extension part,
wherein one end of the elastic member abuts against the stop, and
wherein an other end of the elastic member abuts against the cover body.

7. The aerosol-forming apparatus of claim 1, wherein the vaporization assembly further comprises a sealing member sleeved on an outer surface of the liquid storage body for fixing the cover body and sealing a connection location between the cover body and the liquid storage body.

8. The aerosol-forming apparatus of claim 1, wherein the vaporization assembly further comprises a cooling body detachably connected to the liquid storage body for cooling an aerosol generated by the heating body through vaporization.

9. The aerosol-forming apparatus of claim 8, wherein the cooling body comprises:
a connecting part detachably connected to the liquid storage body and in communication with the liquid storage vaporization cavity; and
a cooling part in communication with the connecting part and configured to accommodate condensate.

10. The aerosol-forming apparatus of claim 1, further comprising:
a power supply assembly detachably connected to the vaporization assembly to supply power to the vaporization assembly.

11. The aerosol-forming apparatus of claim 10, wherein the power supply assembly comprises:
a housing having an accommodating cavity;
a battery accommodated in the accommodating cavity and configured to provide electric energy;
a circuit board accommodated in the accommodating cavity and connected to the battery; and
a coil formed in a circumferential direction of the heating body and in electric communication with the circuit board, the coil being configured to generate a magnetic field when power is applied so as to heat up the heating body by electromagnetic induction.

12. The aerosol-forming apparatus of claim 11, wherein a first recession part is formed on a surface of one side of the housing,
wherein the coil is disposed on an inner surface of the first recession part in a circumferential direction of the first recession part, and
wherein at least a part of the liquid storage body and at least a part of the heating body are located in the first recession part so as to heat up the heating body by electromagnetic induction when the coil is energized.

13. The aerosol-forming apparatus of claim 12, wherein a second recession part is further formed on the surface of one side of the housing,
wherein the vaporization assembly further comprises a cooling body comprising a cooling part in communication with the liquid storage vaporization cavity, and
wherein at least a part of the cooling part is accommodated in the second recession part so as to fix the cooling body.
